(19) United States
(12) Patent Application Publication
(10) Pub. No.: US 2026/0221776 A1
(43) Pub. Date: Jul. 30, 2026

(54) DISTRIBUTED ENERGY RESOURCE MANAGEMENT SYSTEM, CONTROL METHOD, AND RECORDING MEDIUM

(71) Applicant: Mitsubishi Electric Corporation, Chiyoda-ku, Tokyo (JP)

(72) Inventors: Keishi MATSUDA, Tokyo (JP); Shunsuke KAWANO, Tokyo (JP)

(73) Assignee: Mitsubishi Electric Corporation, Chiyoda-ku, Tokyo (JP)

(21) Appl. No.: 19/144,615

(22) PCT Filed: Mar. 1, 2023
(86) PCT No.: PCT/JP2023/007468

§ 371 Date: Jun. 30, 2025

(51) Int. Cl. H02J 3/38; H02J 3/17; H02J 3/18

(52) U.S. Cl. CPC H02J 3/38; H02J 3/17; H02J 3/18

(57) ABSTRACT

A distributed energy resource management system includes a power flow calculation unit configured to calculate a power flow of a voltage and a current at each point in a power distribution system based on system information including information indicating an installation location and a connection form of a distributed energy resource connected to the power distribution system and load power generation information including information indicating a load and a power generation amount at each point in the power distribution system, a system reduction unit configured to generate a reduced power distribution system obtained by reducing the power distribution system based on a calculation result by the power flow calculation unit and the installation location of the distributed energy resource, and a power control amount calculation unit configured to calculate a power control amount controlled by the distributed energy resource by using the reduced power distribution system.

### TECHNICAL FIELD

The present disclosure relates to a distributed energy resource management system, a distributed energy resource management control device, a control method, and a program.

### BACKGROUND ART

Distributed energy resources (DERs) such as photovoltaic power generation, electric vehicles, and storage batteries are increasingly being adopted. In order to appropriately maintain the voltage and the current of a power transmission and distribution system at a lower cost, a distributed energy resource management control device (distributed energy resource management systems (DERMS)) that manages and controls the distributed energy resource instead of the reinforcement of the system has been attracting attention. As a method of optimizing how much each of the distributed energy resources is controlled, optimal power flow (OPF) is used. The optimal power flow (OPF) optimizes and determines the control allocation of each distributed energy resource while satisfying the constraints of the voltage and the current of the system, for example, to minimize the cost.

When optimal power flow (OPF) is executed, it is necessary to solve equations as many as the number of nodes and branches of the system, and thus, from the viewpoint of convergence and calculation time, it is desirable that the number of nodes and branches of the system is small. Therefore, a technology of reducing a calculation load by reducing a system and executing optimal power flow (OPF) is disclosed (for example, Patent Document 1).

### CITATION LIST

### Patent Document

Patent Document 1: Japanese Patent No. 7040693

### SUMMARY OF INVENTION

### Technical Problem

However, the technology disclosed in Patent Document 1 has the premise that a power distribution system and the following system are reduced as one distributed energy resource when the systems are reduced, and the control range of the reduced distributed energy resource is approximately calculated. Therefore, the equivalence is not maintained with respect to the reduction, and optimal power flow (OPF) cannot be performed with high accuracy in some cases.

The present disclosure has been made in view of the above circumstances, and an object of the present disclosure is to provide a distributed energy resource management system, a distributed energy resource management control device, a control method, and a program capable of reducing a power distribution system to which a distributed energy resource is connected such that accuracy of optimal power flow (OPF) is maintained.

### Solution to Problem

A distributed energy resource system according to the present disclosure includes a power flow calculation unit configured to calculate a power flow of a voltage and a current at each point in a power distribution system based on system information including information indicating an installation location and a connection form of a distributed energy resource connected to the power distribution system and load power generation information including information indicating a load and a power generation amount at each point in the power distribution system, a system reduction unit configured to generate a reduced power distribution system obtained by reducing the power distribution system based on a calculation result by the power flow calculation unit and the installation location of the distributed energy resource, and a power control amount calculation unit configured to calculate a power control amount controlled by the distributed energy resource by using the reduced power distribution system.

In addition, a distributed energy resource management control device according to the present disclosure includes a power flow calculation unit configured to calculate a power flow of a voltage and a current at each point in a power distribution system based on system information including information indicating an installation location and a connection form of a distributed energy resource connected to the power distribution system and load power generation information including information indicating a load and a power generation amount at each point in the power distribution system, a system reduction unit configured to generate a reduced power distribution system obtained by reducing the power distribution system based on a calculation result by the power flow calculation unit and the installation location of the distributed energy resource, and a power control amount calculation unit configured to calculate a power control amount controlled by the distributed energy resource by using the reduced power distribution system.

In addition, a control method in a distributed energy resource management system according to the present disclosure includes a step of calculating, via a power flow calculation unit, a power flow of a voltage and a current at each point in a power distribution system based on system information including information indicating an installation location and a connection form of a distributed energy resource connected to the power distribution system and load power generation information including information indicating a load and a power generation mount at each point in the power distribution system, a step of generating, via a system reduction unit, a reduced power distribution system obtained by reducing the power distribution system based on a calculation result by the power flow calculation unit and the installation location of the distributed energy resource, and a step of calculating, via a power control amount calculation unit, a power control amount controlled by the distributed energy resource by using the reduced power distribution system.

In addition, a program according to the present disclosure causes a computer to execute a step of calculating a power flow of a voltage and a current at each point in a power distribution system based on system information including information indicating an installation location and a connection form of a distributed energy resource connected to the power distribution system and load power generation information including information indicating a load and a power generation amount at each point in the power distribution system, a step of generating a reduced power distribution system obtained by reducing the power distribution system based on a calculation result of the power flow and the installation location of the distributed energy resource, and a step of calculating a power control amount controlled by the distributed energy resource by using the reduced power distribution system.

### Advantageous Effects of Invention

According to the present disclosure, the power distribution system to which the distributed energy resource is connected can be reduced such that the accuracy of optimal power flow (OPF) is maintained.

### BRIEF DESCRIPTION OF DRAWINGS

FIG. 1 A system diagram representing a configuration example of a distributed energy resource management system according to a first embodiment.

FIG. 2 A schematic block diagram representing an example of a configuration of a DERMS according to the first embodiment.

FIG. 3 An explanatory diagram of a DER controllable amount according to the first embodiment.

FIG. 4 A schematic diagram representing a reduction example of a power distribution system according to the first embodiment.

FIG. 5 A schematic diagram representing an example of a PQ designated load after reduction according to the first embodiment.

FIG. 6 A schematic diagram representing an example of upper and lower limits of a voltage at each point after reduction according to the first embodiment.

FIG. 7 A flowchart representing an example of optimal power flow control processing according to the first embodiment.

FIG. 8 A system diagram representing a configuration example of a distributed energy resource management system according to a second embodiment.

FIG. 9 A system diagram representing a configuration example of a distributed energy resource management system according to a third embodiment.

FIG. 10 A system diagram representing a configuration example of a distributed energy resource management system according to a fourth embodiment.

FIG. 11 A system diagram representing a configuration example of a distributed energy resource management system according to a fifth embodiment.

FIG. 12 A schematic block diagram representing an example of a configuration of a DERMS according to the fifth embodiment.

FIG. 13 A flowchart representing an example of optimal power flow control processing according to the fifth embodiment.

FIG. 14 A system diagram representing a configuration example of a distributed energy resource management system according to a sixth embodiment.

FIG. 15 A schematic block diagram representing an example of a configuration of a DERMS according to the sixth embodiment.

FIG. 16 A flowchart representing an example of optimal power flow control processing according to the sixth embodiment.

FIG. 17 A schematic block diagram representing an example of a hardware configuration according to the embodiment.

### DESCRIPTION OF EMBODIMENTS

Hereinafter, embodiments will be described with reference to the drawings.

### First Embodiment

First, a configuration example of a distributed energy resource management system according to a first embodiment will be described.

### Configuration of Equipment Management System

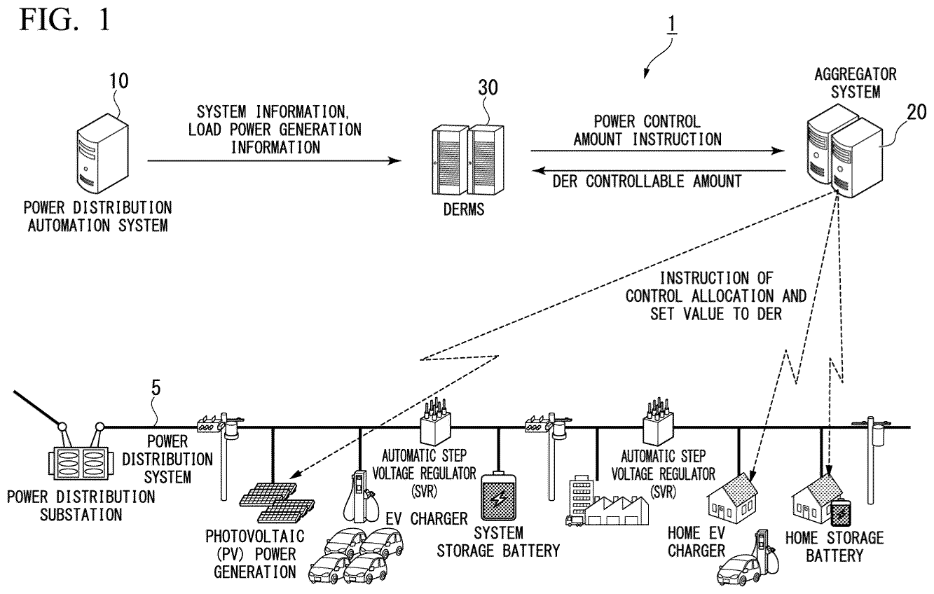

FIG. 1 is a system diagram representing a configuration example of a distributed energy resource management system according to the present embodiment. A distributed energy resource management system 1 represented in the drawing is a system that manages and controls a distributed energy resource (hereinafter, referred to as a “DER”) connected to a power distribution system 5. Examples of the DER connected to the power distribution system 5 include photovoltaic (PV) power generation, an electric vehicle (EV), an EV charger, a system storage battery, a home EV charger, a home storage battery, and the like. In addition, an automatic step voltage regulator (SVR) that is a transformer for automatically adjusting a voltage drop in a power distribution line is provided in the middle of the power distribution system 5.

The distributed energy resource management system 1 has a system reduction means that maintains the equivalence in the process of calculating the allocation of the power control amount of each DER to appropriately maintain the voltage and the current of the power distribution system S to which the DER is connected, and thus can reduce the calculation load while maintaining the accuracy of optimal power flow (OPF). For example, the distributed energy resource management system 1 includes a power distribution automation system 10, an aggregator system 20, and a distributed energy resource management control device 30 (hereinafter, referred to as a “DERMS 30”).

The power distribution automation system 10 is a system owned by a general power transmission and distribution business operator for facility maintenance management distribution system 5, and is configured by one or a plurality of computers (servers). For example, the power distribution automation system 10 has system information and load power generation information of the power distribution system 5. The system information is information such as system topology and line impedance, and includes information indicating an installation location and a connection form of the DER, or the like. For example, the system information is input by a general power transmission and distribution business operator or an administrator.

The load power generation information includes information indicating a load and a power generation amount at each point in the system of the power distribution system 5 (for example, a profile of the active power and the reactive power for each point in the system for each predetermined time (for example, 30 minutes)). For example, the power distribution automation system 10 is connected to a smart meter of each customer and a sensor (a voltage sensor, a current sensor, and the like) installed in the middle of a power distribution line through a communication network, a calculates the load power generation information from a measurement value of the smart meter or a measurement value of the sensor. The power distribution automation system 10 accumulates the system information and the load power generation information in a database or the like.

The aggregator system 20 is configured by one or a plurality of computers (servers). An aggregator is a business operator that efficiently provides the energy management service by bundling the power demand of each customer. For example, the aggregator system 20 grasps (stores) a controllable amount indicating a range of controllable power at each DER connected to the power distribution system 5. In addition, the aggregator system 20 adjusts the power control amount controlled by each DER connected to the power distribution system 5 in response to a command from the DERMS 30.

The DERMS 30 is configured by one or a plurality of computers (servers), and optimizes the power control amount of each DER connected to the power distribution system 5 by performing optimal power flow (OPF). For example, the DERMS 30 acquires and stores the system information and the load power generation information from the power distribution automation system 10 through the communication network. In addition, the DERMS 30 acquires and stores a controllable amount (DER controllable amount) of each DER from the aggregator system 20 through the communication network. The DERMS 30 calculates a power flow of a voltage and a current at each point in the power distribution system 5 based on the system information and the load power generation information, and generates a reduced power distribution system in which the power distribution system 5 is reduced based on a calculation result of the power flow and an installation location of the DER. Then, the DERMS 30 performs optimal power flow (OPF) by using the reduced power distribution system to calculate the power control amount controlled by each DER.

The DERMS 30 transmits information indicating the power control amount (the control amount of the active power and the control amount of the reactive power) controlled by each DER to the aggregator system 20 as a command of the power control amount (hereinafter, referred to as a “power control amount command”) through the communication network. The aggregator system 20 allocates the power control amount to each DER based on the power control amount command acquired from the DERMS 30, and transmits an instruction of a set value of the power control amount to each DER. That is, the DERMS 30 transmits the power control amount to each DER through the aggregator system 20. Each DER is controlled by the power control amount acquired from the aggregator system 20.

### Configuration of DERMS

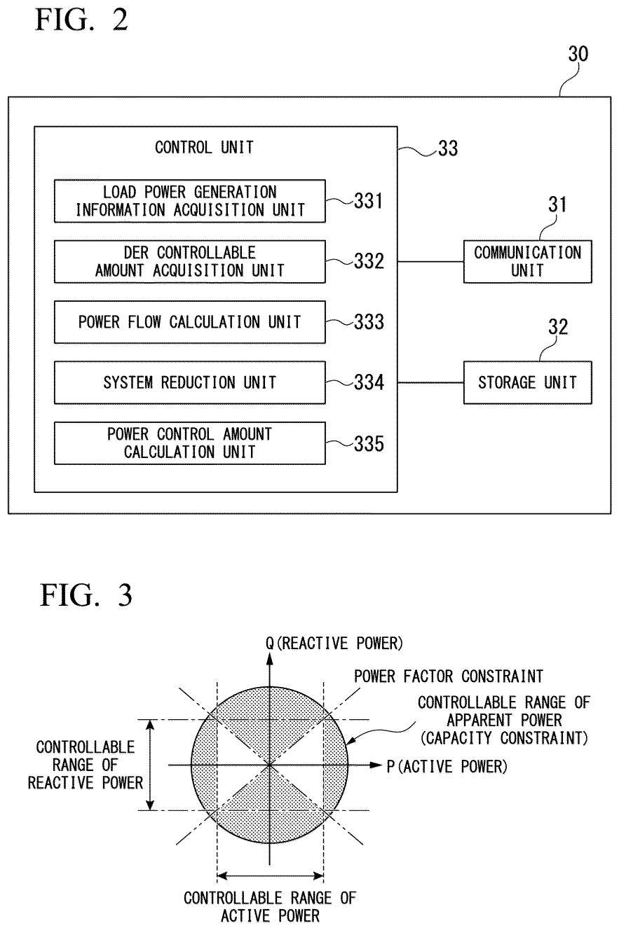

FIG. 2 is a schematic block diagram representing an example of a configuration of the DERMS 30 according to the present embodiment. The DERMS 30 includes a communication unit 31, a storage unit 32, and a control unit 33. The communication unit 31 communicates with the power distribution automation system 10, the aggregator system 20, and the like through a communication network.

The storage unit 32 stores information acquired by the DERMS 30 through a communication network, information generated by the DERMS 30, and the like. For example, the storage unit 32 stores system information, load power generation information (system topology, line impedance, and the like), an installation location of the DER, a DER controllable amount, and the like acquired from the power distribution automation system 10 or the aggregator system 20. In addition, the storage unit 32 stores a processing result by the control unit 33 described later.

The control unit 33 includes a load power generation information acquisition unit 331, a DER controllable amount acquisition unit 332 (an example of a controllable amount acquisition unit), a power flow calculation unit 333, a system reduction unit 334, and a power control amount calculation unit 335, as functional configurations realized by the computer that executes a program.

The load power generation information acquisition unit 331 acquires the system information and the load generation information from the power distribution automation system 10 through the communication unit 31 and stores the system information and the load power generation information in the storage unit 32. For example, the system information includes information indicating a system topology in which a connection form of the power distribution system 5 is modeled by points, lines, and the like, an installation location of the DER connected to the power distribution system 5, and the like.

The DER controllable amount acquisition unit 332 acquires the DER controllable amount from the aggregator system 20 through the communication unit 31 and stores the DER controllable amount in the storage unit 32. For example, the DER controllable amount acquisition unit 332 acquires information on a controllable range of the active power, a controllable range of the reactive power, controllable range of the apparent power, presence or absence of the power factor constraint of each DER from the aggregators system 20. The timing and frequency at which the DER controllable amount acquisition unit 332 acquires the DER controllable amount from each DER are optional, and are, for example, once a day, every 30 minutes, or the like.

FIG. 3 is an explanatory diagram of a DER controllable amount according to the present embodiment. In the figure, a controllable range of the active power, a controllable range of the reactive power, a controllable range of the apparent power (capacity constraint), and a power factor constraint are represented on a PQ coordinate of an active power P and a reactive power Q.

In the figure, the range inside the circle indicates a controllable range (capacity constraint) of the apparent power. In addition, a range inside two broken lines indicates a controllable rang of the active power, and a range inside two one-dot chain lines indicates a controllable range of the reactive power. In addition, a range (a white range in the circle) inside two double-dot chain lines indicates the constraint of the power factor.

The DER controllable amount may include at least a controllable range (capacity constraint) of the apparent power, but it is more preferable also to include a controllable range of the active power, a controllable range of the reactive power, and a power factor constraint.

Returning to FIG. 2, the power flow calculation unit 333 calculates the power flow of the voltage and the current at each point in the power distribution system 5 based on the system information and the load power generation information of the power distribution system 5. That is, the power flow calculation unit 333 calculates how the voltage and the current at each point are changed when there is a certain amount of power generation/load (kW) and reactive power consumption (kVar) at a certain position in the power distribution system 5.

The system reduction unit 334 generates a reduced power distribution system (reduced system topology) in which the power distribution system 5 (system topology) is reduced based on the calculation result by the power flow calculation unit 333 and the installation location of the DER. Specifically, the system reduction unit 334 extracts a range in which the power flow (PQ power flow) of the active power and the reactive power does not change although the power control amount of the DER is controlled in the power distribution system 5 (that is, although the power control amount is changed) based on the calculation result by the power flow calculation unit 333. Then, the system reduction unit 334 reduces a range in which the power flow does not change.

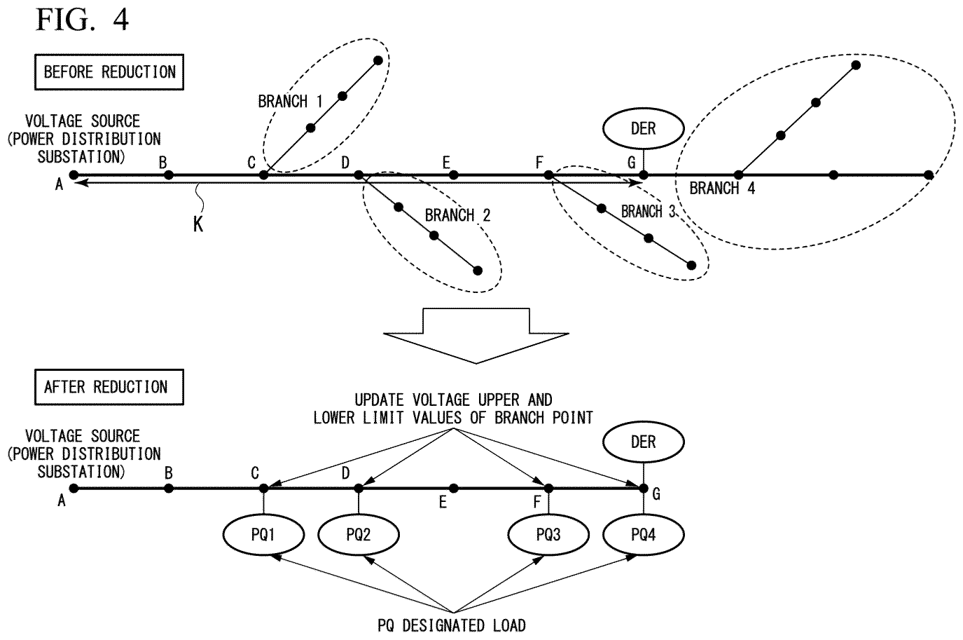

FIG. 4 is a schematic diagram representing a reduction example of the power distribution system according to the present embodiment. The upper part represents the power distribution system before the reduction, and the lower part represents the power distribution system after the reduction. In the power distribution system before reduction, the DER is connected to a branch point G in the power distribution system connected to a voltage source A (power distribution substation). In the power distribution system, a power flow changes in a section K between the voltage source A and the branch point G to which the DER is connected when the DER is controlled. The system reduction unit 334 reduces a range (a range in which the power flow does not change) excluding the section K between the voltage source A and the branch point G to which the DER is connected. In the example represented in the drawing, the ranges of a branch 1, a branch 2, a branch 3, and a branch 4 branched from a branch point C, a branch point D, a branch point F, and a branch point G are ranges in which the power flow does not change although the DER is controlled, and the ranges are reduced.

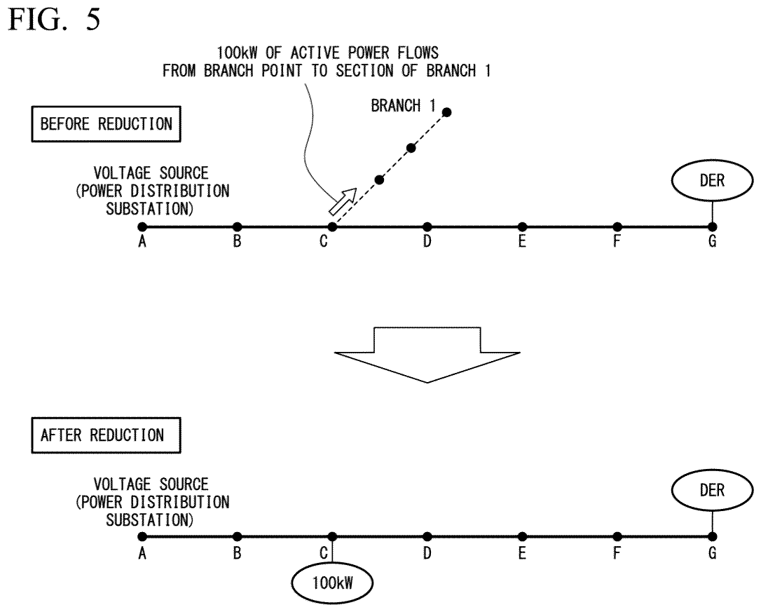

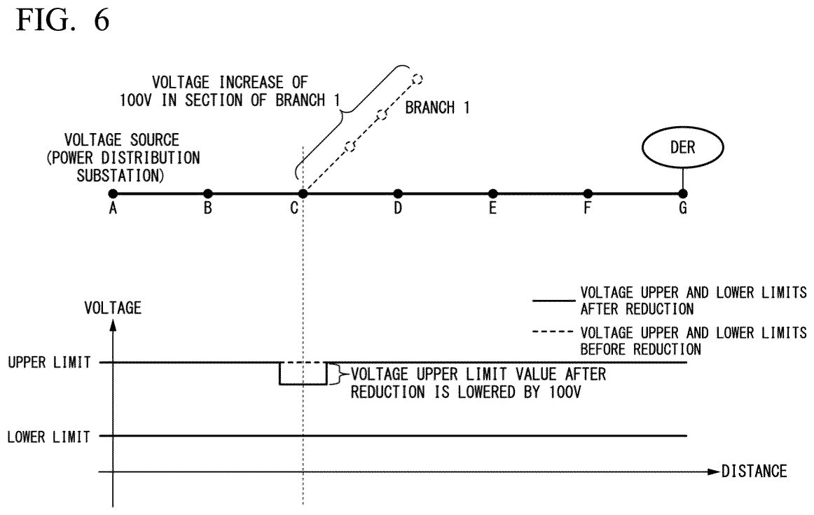

In addition, the system reduction unit 334 omits the range (section of each of the branch 1, the branch 2, the branch 3, and the branch 4) to be reduced in the power distribution system after reduction and handles the range as PQ designated loads PQ1, PQ2, PQ3, and PQ4 according to the electric power that flows into the section. In addition, the system reduction unit 334 updates the voltage upper limit value of each of the branch point C, the branch point D, the branch point F, and the branch point G to the section of the range to be reduced, based on the change amount of the voltage of the section before the reduction. Here, the system reduction unit 334 determines the system condition after reduction (the value of the PQ designated load after reduction, the upper and lower limit values of the voltage of the reduced system, and the like) based on the calculation result by the power flow calculation unit 333. Specifically, the description will be made with reference to FIGS. 5 and 6.

FIG. 5 is a schematic diagram representing an example of the PQ designated load after reduction according to the present embodiment. Here, an example in which the range of the branch 1 represented in FIG. 4 is reduced and handled as the designated load PQ1 is represented. It is possible to know the power that flows into the branched section based on the calculation result by the power flow calculation unit 333. For example, when 100 kW of the active power flows from the branch point C to the section of the branch 1, after the reduction, it is handled that the section of the branch 1 is omitted and a PQ designated load of 100 kW is connected to the branch point C. The same applies to the reactive power, and when 50 kVar of the reactive power flows from the branch point C to the section of the branch 1, it is handled that a PQ designated load of 50 kVar is connected to the branch point C after the reduction.

FIG. 6 is a schematic diagram representing an example of upper and lower limits of a voltage at each point after reduction according to the present embodiment. The upper and lower limits of the voltage are constraints defined by the Electric Business Act of Japan. A change amount ΔV in the voltage of the branched section is known based on the calculation result by the power flow calculation unit 333. For example, when there is a voltage increase of 100 V in the section of the branch 1 branched from the branch point C, after the reduction, the section of the branch 1 is omitted, and the voltage upper limit value of the branch point C is Powered by 100 V. When the constraint of the upper limit value is satisfied by lowering the voltage upper limit value by 100 V, the constraint violation does not occur in the omitted section of the branch 1 although the voltage at the branch point C is changed by the control of the DER.

Returning to FIG. 2, the power control amount calculation unit 335 performs optimal power flow (OPF) by using the reduced power distribution system and determines the allocation of the power control amount controlled by each DER. For example, when the power control amount controlled by each DER is calculated using the reduced power distribution system, the power control amount calculation unit 335 calculates the power control amount such that the power control amount is within the range of the DER controllable amount. The optimization method is not limited to any method, and any known method (a heuristic method, a mathematical optimization method, or the like) can be applied. For example, the power control amount calculation unit 335 determines the control allocation of the DER by optimal power flow (OPF) such that the voltage and the current in the power distribution system 5 are within an appropriate range and the total control cost is minimized.

The communication unit 31 transmits the power control amount calculated by the power control amount calculation unit 335 to the DER. For example, the communication unit 31 transmits the power control amount to the DER through the gator system 20.

### Operation of Optimal Power Flow Control Processing

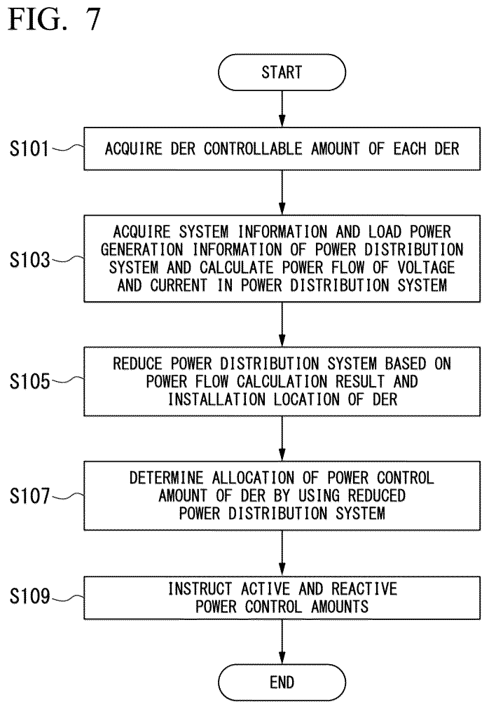

Next, an operation of the optimal power flow control processing in which the DERMS 30 reduces the power distribution system 5 and performs optimal power flow (OPF) will be described with reference to FIG. 7. FIG. 7 is a flowchart representing an example of optimal power flow control processing according to the present embodiment.

(Step S101) The DERMS 30 acquires and stores the DER controllable amount of each DER connected to the power distribution system 5 from the aggregator system 20. Thereafter, the process proceeds to step S103.

(Step S103) The DERMS 30 acquires the system information and the load power generation information of the power distribution system 5 from the power distribution automation system 10, and calculates the power flow of the voltage and the current at each point in the power distribution system 5 based on the acquired system information and load power generation information. The DERMS 30 may acquire the system information of the power distribution system 5 in advance from the power distribution automation system 10. Thereafter, the process proceeds to step S105.

(Step S105) The DERMS 30 generates a reduced power distribution system in which the power distribution system 5 is reduced, based on the power flow calculation result in the step S103 and the installation location of the DER (see FIGS. 4 to 6). Thereafter, the process proceeds to step S107.

(Step S107) The DERMS 30 performs optimal power flow (OPF) by using the reduced power distribution system and determines the allocation of the power control amount controlled by each DER. Thereafter, the process proceeds to step S109.

(Step S109) The DERMS 30 transmits a power control amount command for notifying the power control amount of each DER determined in the step S107 to the aggregator system 20. That is, the DERMS 30 transmits the power control amount of each DER determined in the step S107 to each DER through the aggregator system 20.

As described above, the distributed energy resource management system 1 according to the present embodiment calculates the power flow of the voltage and the current at each point in the power distribution system 5 based on the system information including the information indicating the installation location and the connection form of the DER (distributed energy resource) connected to the power distribution system 5 and the load power generation information including the information indicating the load and the power generation amount at each point in the power distribution system 5. In addition, the distributed energy resource management system 1 generates a reduced power distribution system in which the power distribution system 5 is reduced, based on the power flow calculation result and the installation location of the DER. Then, the distributed energy resource management system 1 calculates the power control amount controlled by the DER by using the reduced power distribution system.

As a result, the distributed energy resource management system 1 reduces the power distribution system 5 based on the power flow of the voltage and the current at each point in the power distribution system 5, and thus can reduce the power distribution system 5 to which the DER is connected such that the accuracy of optimal power flow (OPF) is maintained. Therefore, the distributed energy resource management system 1 can reduce the calculation load while maintaining the accuracy of optimal power flow (OPF).

In addition, the distributed energy resource management system 1 acquires a DER controllable amount (an example of a controllable amount) indicating a range of controllable power in the DER. Then, the distributed energy resource management system 1 calculates the power control amount such that the power control amount is within the range of the DER controllable amount when calculating the power control amount controlled by the DER by using the reduced power distribution system.

As a result, the distributed energy resource management system 1 can optimize the power control amount of each DER connected to the power distribution system 5 within the range of the DER controllable amount.

The distributed energy resource management system 1 may calculate the power control amount controlled by the DER by using the reduced power distribution system without acquiring the DER controllable amount (without using the DER controllable amount). For example, the aggregator system 20 may check whether or not the power control amount calculated by the distributed energy resource management system 1 is within the range of the DER controllable amount.

For example, the distributed energy resource management system 1 reduces a range in which the power flow does not change although the power control amount of the DER is controlled in the power distribution system 5.

As a result, the distributed energy resource system 1 can reduce the range in which the power flow does not change although the DER is controlled, and thus can reduce the power distribution system 5 to which the DER is connected such that the accuracy of optimal power flow (OPF) is maintained.

For example, the distributed energy resources management system 1 reduces a range excluding a section between the voltage source and the DER in which the power control amount can be controlled in the power distribution system 5.

As a result, the distributed energy resource management system 1 reduces the range excluding the section between the voltage source and the DER in the power distribution system 5, and thus can reduce the power distribution system 5 to which the DER is connected such that the accuracy of optimal power flow (OPF) is maintained.

In addition, the distributed energy resource management system 1 handles a section of a range to be reduced in the power distribution system 5 as a PQ designated load (an example of a load) according to the power that flows into the section.

As a result, the distributed energy resource management system 1 reduces the range in which the power flow does not change as the PQ designated load, and thus can reduce the power distribution system 5 to which the DER is connected such that the accuracy of optimal power flow (OPF) is maintained.

In addition, the distributed energy resource management system 1 updates the voltage upper limit value of the branch point to the section of the range to be reduced in the power distribution system 5 based on the change of the section.

As a result, the distributed energy resource management system 1 can perform optimal power flow (OPF) by using the reduced power distribution system such that the constraint violation of the voltage upper limit value does not occur.

In addition, the distributed energy resource management system 1 transmits the power control amount calculated by using the reduced power distribution system to the DER.

As a result, the distributed energy resource management system 1 can optimize the power control amount of the DER connected to the power distribution system 5.

For example, the distributed energy resource management system 1 transmits the power control amount from the DERMS 30 to the DER through the aggregator system 20 (an example of a server included in the aggregator).

As a result, the distributed energy resource management system 1 can optimize the power control amount of each DER connected to the power distribution system 5.

In addition, in the distributed energy resource management system 1 the DERMS 30 acquires the system information and the load power generation information of the power distribution system 5 from the power distribution automation system 10 (an example of a server owned by the general power transmission and distribution business operator).

As a result, the distributed energy resource management system 1 can calculate the power flow of the voltage and the current at each point in the power distribution system 5.

In addition, in the distributed energy resource management system 1, the DERMS 30 acquires the DER controllable amount from the aggregator system 20.

As a result, the distributed energy resource management system 1 can grasp a range of controllable power of each DER connected to the power distribution system 5, and can optimize the power control amount of each DER within the range of the DER controllable amount.

In addition, the DERMS 30 (distributed energy resource management control device) according to the present embodiment calculates the power flow of the voltage and the current at each point in the power distribution system 5 based on the system information including the information indicating the installation location and the connection form of the DER (distributed energy resource) connected to the power distribution system 5 and the load power generation information including the information indicating the load and the power generation amount at each point in the power distribution system 5. In addition, the distributed energy resource management system 1 generates a reduced power distribution system in which the power distribution system 5 is reduced, based on the power flow calculation result and the installation location of the DER. Then, the distributed energy resource management system 1 calculates the power control amount controlled by the DER by using the reduced power distribution system.

As a result, the DERMS 30 reduces the power distribution system 5 based on the power flow of the voltage and the current at each point in the power distribution system 5, and thus can reduce the power distribution system 5 to which the DER is connected such that the accuracy of optimal power flow (OPF) is maintained. Therefore, the distributed energy resource management system 1 can reduce the calculation load while maintaining the accuracy of optimal power flow (OPF).

In addition, a DER control method in the distributed energy resource management system 1 according to the present embodiment includes a step of calculating a power flow of a voltage and a current at each point in the power distribution system 5 by the power flow calculation unit 333 based on system information including information indicating an installation location and a connection form of the DER connected to the power distribution system 5 and load power generation information including information indicating a load and a power generation amount at each point in the power distribution system 5, a step of generating a reduced power distribution system obtained by reducing the power distribution system 5 by the system reduction unit 334 based on a calculation result by the power flow calculation unit 333 and the installation location of the DER, and a step of calculating a power control amount controlled by the DER by using the reduced power distribution system by the power control amount calculation unit 335.

As a result, the DER control method in the distributed energy resource management system 1 reduces the power distribution system 5 based on the power flow of the voltage and the current at each point in the power distribution system 5, and thus can reduce the power distribution system 5 to which the DER is connected such that the accuracy of optimal power flow (OPF) is maintained. Therefore, the calculation load can be reduced while maintaining the accuracy of optimal power flow (OPF).

In addition, a program in the distributed energy resource management system 1 according to the present embodiment causes the computer to execute a step of calculating a power flow of a voltage and a current at each point in the power distribution system 5 based on system information including information indicating an installation location and a connection form of the DER connected to the power distribution system 5 and load power generation information including information indicating a load and a power generation amount at each point in the power distribution system 5, a step of generating a reduced power distribution system obtained by reducing the power distribution system 5 based on a calculation result of the power flow and the installation location of the DER, and a step of calculating a power control amount controlled by the DER by using the reduced power distribution system.

As a result, the program in the distributed energy resource management system 1 reduces the power distribution system 5 based on the power flow of the voltage and the current at each point in the power distribution system 5, and thus can reduce the power distribution system 5 to which the DER is connected such that the accuracy of optimal power flow (OPF) is maintained. Therefore, the calculation load can be reduced while maintaining the accuracy of optimal power flow (OPF).

### Second Embodiment

Next, a second embodiment will be described.

In the distributed energy management system 1 according to the first embodiment, the DERMS 30 transmits power control amount to each DER through the aggregator system 20, but in the present embodiment, the transmission may be performed directly to each DER without going through the a gator system 20.

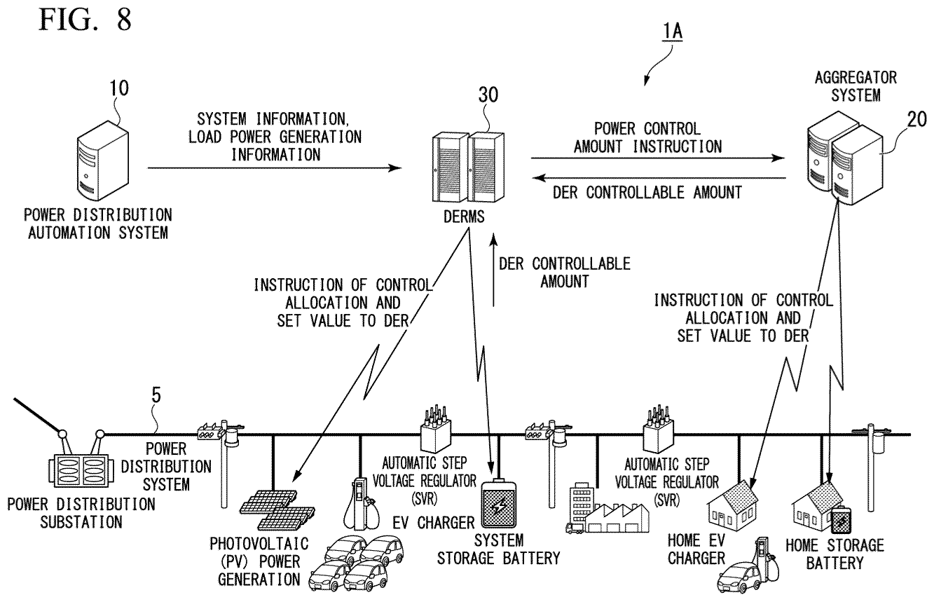

FIG. 8 is a system diagram representing a configuration example of a distributed energy resource management system according to the present embodiment. In the figure, the same reference numerals are assigned to the configurations corresponding to the each part represented in FIG. 1. In a distributed energy resource management system 1A represented in the drawing, some of the plurality of DERs connected to the power distribution system 5 is not managed by the aggregator system 20, and the DERs are in direct communication with the DERMS 30.

The DER controllable amount acquisition unit 332 of the DERMS 30 acquires the DER controllable amount from the aggregator system 20 through the communication unit 31 with respect to the DER managed by the aggregator system 20. In addition, the power control amount calculation unit 335 transmits a power control amount command for notifying the DER of the power control amount (control amount of active power and reactive power) calculated by using optimal power flow (OPF) to the aggregator system 20 through the communication unit 31. The aggregator system 20 allocates the power control amount to each DER based on the power control amount command acquired from the DERMS 30, and transmits an instruction of a set value of the power control amount to each DER.

On the other band, the DER controllable amount acquisition unit 332 directly acquires the DER controllable amount from the DER without going through the aggregator system 20 with respect to the DER that is not managed by the aggregator system 20. In addition, the power control amount calculation unit 335 allocates the power control amount to each DER and transmits an instruction of a set value of the power control amount directly to each DER. That is, the DERMS 30 directly transmits the power control amount to each DER without going through the aggregator system 20.

As described above, in the distributed energy resource management system 1A according to the present embodiment, the DERMS 30 can also directly transmit the power control amount to the DER without going through the aggregator system 20.

As a result, the distributed energy resource management system 1A can optimize the power control amount of each DER connected to the power distribution system 5. In addition, similarly to the distributed energy resource management system 1 according to the first embodiment, the distributed energy resource management system 1A can reduce the power distribution system 5 to which the DER is connected such that the accuracy of optimal power flow (OPF) is maintained, and can reduce the calculation load while maintaining the accuracy of optimal power flow (OPF).

In addition, in the distributed energy resource management system 1A, the DERMS 30 directly acquires the DER controllable amount from the DER without going through the aggregator system 20.

As a result, the distributed energy resource management system 1A can grasp a range of controllable power of each DER connected to the power distribution system 5, and can optimize the power control amount of each DER within the range of the DER controllable amount

### Third Embodiment

Next, a third embodiment will be described.

When the DER connected to the power distribution system 5 includes the DER owned by the general power transmission and distribution business operator, the DER is managed by the power distribution automation system 10. In the present embodiment, the DERMS 30 transmits the power control amount to the DER managed by the power distribution automation system 10 through the power distribution automation system 10.

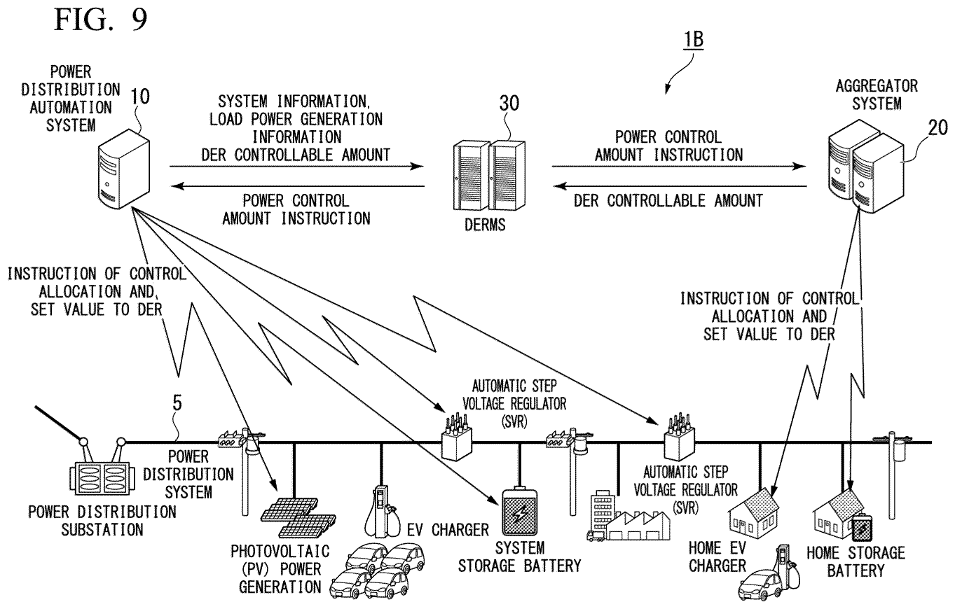

FIG. 9 is a system diagram representing a configuration example of a distributed energy resource management system according to the present embodiment. In the figure, the same reference numerals are assigned to the configurations corresponding to the each part represented in FIG. 1. In a distributed energy resource management system 1B represented in the drawing, some of the plurality of DERs connected to the power distribution system 5 are managed by the power distribution automation system 10.

The DER controllable amount acquisition unit 332 of the DERMS 30 acquires the DER controllable amount from the power distribution automation system 10 through the communication unit 31 with respect to the DER managed by the power distribution automation system 10. In addition, the power control amount calculation unit 335 transmits information indicating the power control amount (control amount of active power and reactive power) calculated by using optimal power flow (OPF) as a power control amount command to the power distribution automation system 10 through the communication unit 31. The power distribution automation system 10 allocates the power control amount to each DER based on the power control amount command acquired from the DERMS 30, and transmits an instruction of a set value of the power control amount to each DER.

The DER controllable amount acquisition unit 332 of the DERMS 30 acquires the DER controllable amount from the aggregator system 20 through the communication unit 31 with respect to the DER managed by the aggregator system 20. In addition, the power control amount calculation unit 335 transmits information indicating the power control amount (control amount of active power and reactive power) calculated by using optimal power flow (OPF) as a power control amount command to the aggregator system 20 through the communication unit 31. The aggregator system 20 allocates the power control amount to each DER based on the power control amount command acquired from the DERMS 30, and transmits an instruction of a set value of the power control amount to each DER.

As described above, in the distributed energy resource management system 1A according to the present embodiment, the DERMS 30 transmits the power control amount to the DER through the power distribution automation system 10.

As a result, the distributed energy resource management system 1B can optimize the power control amount of each DER connected to the power distribution system 5. In addition, similarly to the distributed energy resource management system 1 according to the first embodiment, the distributed energy resource management system 1B can reduce the power distribution system 5 to which the DER is connected such that the accuracy of optimal power flow (OPF) is maintained, and can reduce the calculation load while maintaining the accuracy of optimal power flow (OPF).

In addition, in the distributed energy resource management system 1B, the DERMS 30 acquires the DER controllable amount from the power distribution automation system 10.

As a result, the distributed energy resource management system 1B can grasp a range of controllable power of each DER connected to the power distribution system 5, and can optimize the power control amount of each DER within the range of the DER controllable amount.

### Fourth Embodiment

Next, a fourth embodiment will be described.

In the distributed energy resource management systems 1, 1A, and 1B (see FIGS. 1, 8, and 9) according to the first to third embodiments, a configuration example in which the DERMS 30 communicates with the aggregator system 20 has been described, but the DERMS 30 may communicate with the aggregator system 20 through another system.

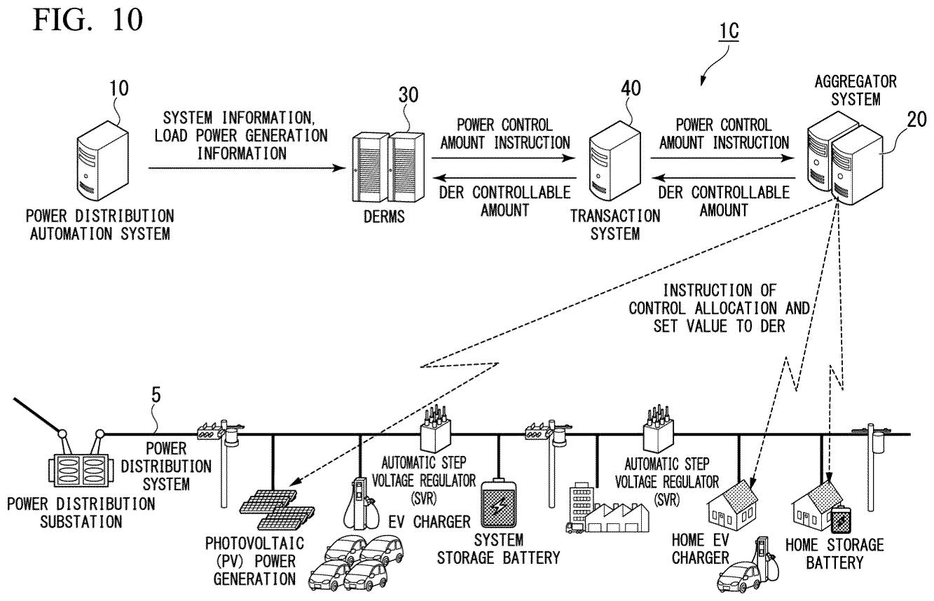

FIG. 10 is a system diagram representing a configuration example of a distributed energy resource management system according to the present embodiment. In the figure, the same reference numerals are assigned to the configurations corresponding to the each part represented in FIG. 1. In a distributed energy resource management system 1C represented in the drawing, the DERMS 30 acquires the DER controllable amount from the aggregator system 20 through a transaction system 40, and the DERMS 30 transmits the power control amount command to the aggregator system 20 through the transaction system 40, which is different from the configuration represented in FIG. 1.

The transaction system 40 is configured by one or a plurality of computers (servers), and may be a system operated by a business operator different from the general power transmission and distribution business operator and the aggregator. For example, the transaction system 40 acquires and stores the DER controllable amount from the aggregator system 20, and transmits the DER controllable amount to the DERMS 30 in response to an acquisition request from the DERMS 30. In addition, when the power control amount command is acquired from the DERMS 30, the transaction system 40 transmits the acquired power control amount command to aggregator system 20.

As described above, in the distributed energy resource management system 1C according to the present embodiment, even in a configuration in which the DERMS 30 and the aggregator system 20 communicate with each other through the transaction system 40 (an example of another system), similarly to the distributed energy resource management system 1 according to the first embodiment, the power distribution system 5 to which the DER is connected can be reduced such that the accuracy of optimal power flow (OPF) is maintained, and the calculation load can be reduced while maintaining the accuracy of optimal power flow (OPF).

The distributed energy resource management 1C represented in FIG. 10 is a configuration example in which the transaction 40 is added to the configuration of the distributed energy resource system 1 represented in FIG. 1, but may be a configuration in which the transaction system 40 is added to the distributed energy resource management system 1A represented in FIG. 8 and the distributed energy resource management system 1B represented in FIG. 9.

### Fifth Embodiment

Next, a fifth embodiment will be described.

In the present embodiment, a configuration example in which the power flow of the voltage and the current at each point in the power distribution system 5 is calculated based on a future prediction of a load and a power generation amount at each point in the power distribution system 5 will be described.

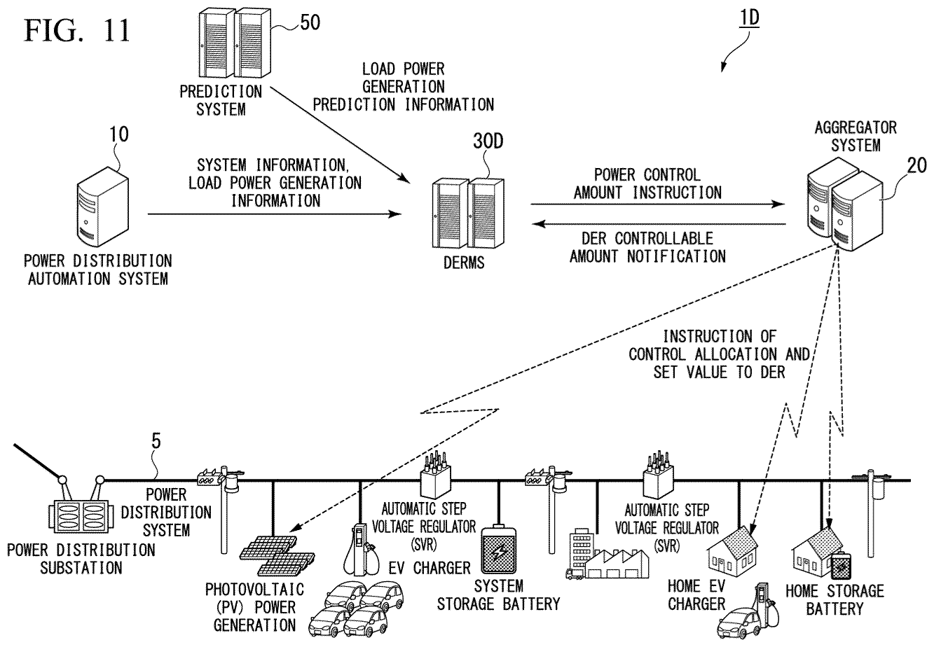

FIG. 11 is a system diagram representing a configuration example of a distributed energy resource management system according to the present embodiment. In the figure, the same reference numerals are assigned to the configurations corresponding to the each part represented in FIG. 1. A distributed energy resource management system 1D represented in the drawing is different from the configuration represented in FIG. 1 in that a prediction system 50 is provided, and the DERMS 30D acquires the future prediction of the load and the power generation amount at each point in the power distribution system 5 from the prediction system 50 and performs the power flow calculation.

The prediction system 50 is configured by one or a plurality of computers (servers). For example, the prediction system 50 predicts a future load demand and power generation amount (for example, prediction for each time point) from information such as a profile of a past load and power generation amount, a season, and a time point at each point in the power distribution system 5. The prediction system 50 transmits the load power generation prediction information including information indicating the future prediction of the load and the power generation amount at each point in the power distribution system 5 to a DERMS 30D.

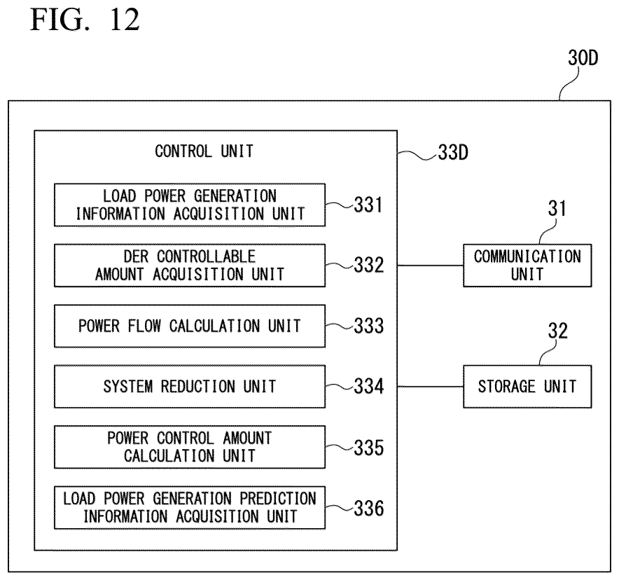

FIG. 12 is a schematic block diagram representing an example of a configuration of the DERMS 30D according to the present embodiment. In the figure, the same reference numerals are assigned to the configurations corresponding to the each part represented in FIG. 2. The DERMS 30D represented in the drawing is different from the configuration of the DERMS 30 represented in FIG. 2 in that a control unit 33D includes a load power generation prediction information acquisition unit 336.

The load power generation prediction information acquisition unit 336 acquires load power generation prediction information including information indicating a future prediction of the load and the power generation amount at each point in the power distribution system 5 from the prediction system 50. The power flow calculation unit 333 calculates the power flow of the voltage and the current at each point in the power distribution system 5 based on the system information of the power distribution system 5 and the load power generation prediction information.

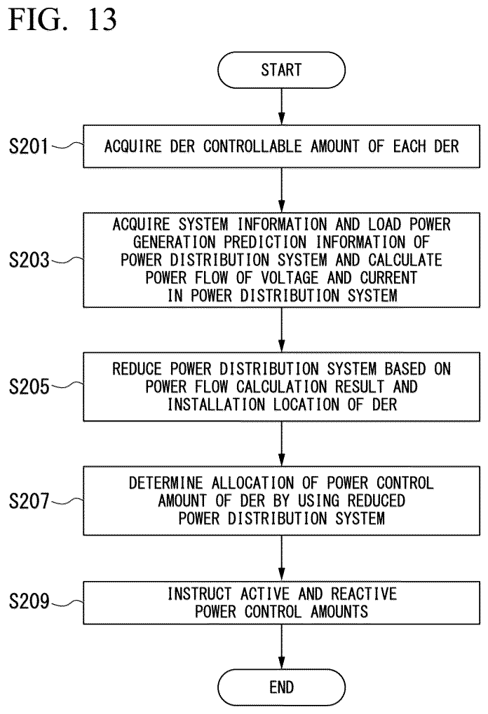

FIG. 13 is a flowchart representing an example of optimal power flow control processing according to the present embodiment. Each processing of steps S201, S205, S207, and S209 in the figure is the same processing as each processing of the steps S101, S105, S107, and S109 represented in FIG. 7, and the description thereof will be omitted.

(Step S203) The DERMS 30D acquires the system information and the load power generation information of the power distribution system 5 from the power distribution automation system 10. The DERMS 30D may acquire the system information of the power distribution system 5 in advance from the power distribution automation system 10. In addition, the DERMS 30D acquires the load power generation prediction information of the power distribution system 5 from the prediction system 50. Then, the DERMS 30D calculates the power flow of the voltage and the current at each point in the power distribution system 5 based on the system information and the load power generation prediction information of the power distribution system 5. Thereafter, the process proceeds to the step S205.

The processing after the step S205 is the same as the processing represented in FIG. 7, and the DERMS 30D reduces the power distribution system 5 based on the power flow calculation result in the step S203 and the installation location of the DER (step S205), performs optimal power flow (OPF) by using the reduced power distribution system (step S207), and transmits the power control amount command to the aggregator system 20 (step S209).

As described above, in the distributed energy resource management system 1D according to the present embodiment, the DERMS 30D acquires the load power generation prediction information including information indicating a future prediction of the load and the power generation amount at each point in the power distribution system 5. Then, the DERMS 30D calculates the power flow of the voltage and the current at each point in the power distribution system 5 based on the system information and the load power generation prediction information of the power distribution system 5.

As a result, the distributed energy resource management system 1D can optimize the power control amount of each DER connected to the power distribution system 5 based on the future prediction of the load and the power generation amount at each point in the power distribution system 5.

The distributed energy resource management system 1D represented in FIG. 11 is a configuration example in which the prediction system 50 is added to the configuration of the distributed energy resource management system 1 represented in FIG. 1, but may be a configuration in which the transaction system 40 is added to the distributed energy resource management system 1A represented in FIG. 81 the distributed energy resource management system 1B represented in FIG. 9, and the distributed energy resource management system 1C represented in FIG. 10.

### Sixth Embodiment

Next, a sixth embodiment will be described.

In the present embodiment, the power flow calculation is performed based on the future prediction of the load and the power generation amount at each point in the power distribution system 5, as in the fifth embodiment, but there is a difference in that the DERMS itself predicts the load and the power generation amount.

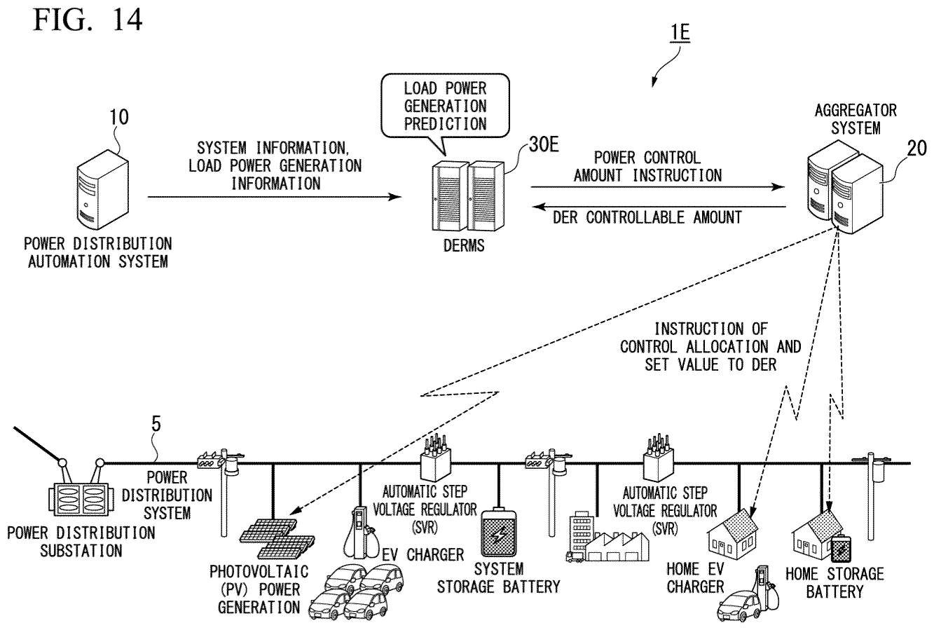

FIG. 14 is a system diagram representing a configuration example of a distributed energy resource management system according to the present embodiment. In the figure, the same reference numerals are assigned to the configurations corresponding to the each part represented in FIG. 1. A distributed energy resource management system 1E represented in the drawing has a difference in that, instead of the DERMS 30 of the configuration represented in FIG. 1, a DERMS 30E predicts the future of the load and the power generation amount at each point in the power distribution system 5.

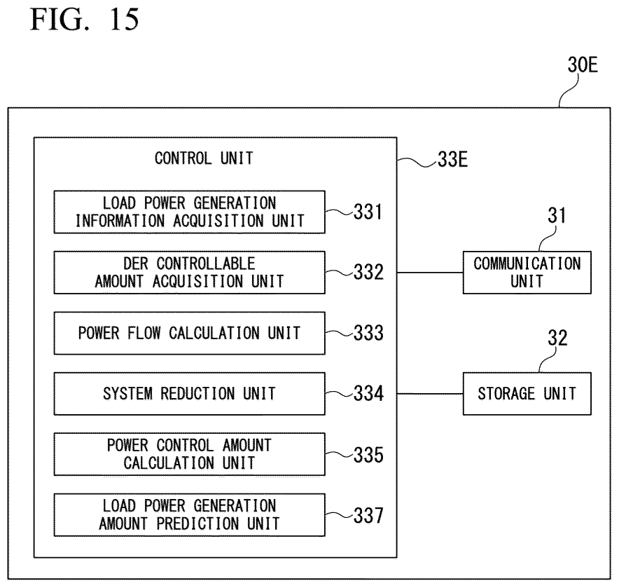

FIG. 15 is a schematic block diagram representing an example of a configuration of the DERMS 30E according to the present embodiment. In the figure, the same reference numerals are signed to the configurations corresponding to the each part represented in FIG. 2. The DERMS 30E represented in the drawing is different from the DERMS 30 represented in FIG. 2 in that a control unit 33E includes a load power generation amount prediction unit 337.

The load power generation amount prediction unit 337 generates the profile of the past load and power generation amount at each point in the power distribution system 5 based on the load power generation information acquired by the load power generation information acquisition unit 331, and predicts the future load demand and power generation amount (for example, prediction for each time point) from information such as a season and a time. The power flow calculation unit 333 calculates the power flow of the voltage and the current at each point in the power distribution system 5 based on the system information of the power distribution system 5 and the prediction of the load and the power generation amount by the load power generation amount prediction unit 337.

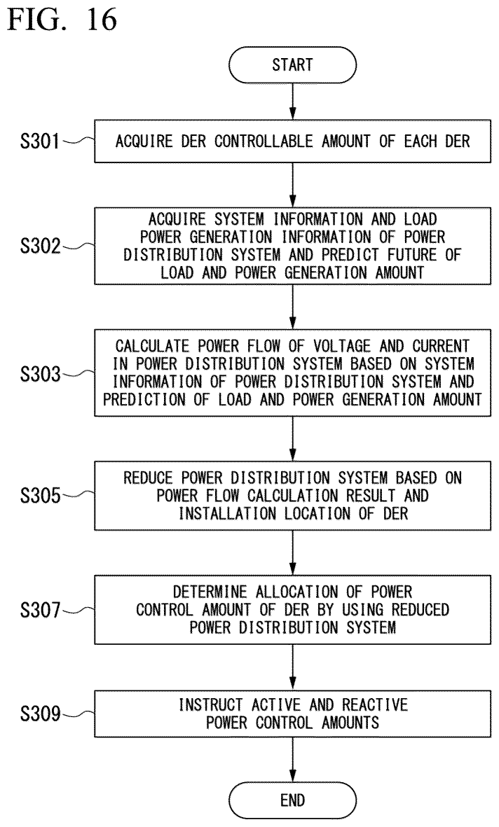

FIG. 16 is a flowchart representing an example of optimal power flow control processing according to the present embodiment. Each processing of steps S301, S305, S307, and S309 in the figure is the same processing as each processing of the steps S101, S105, S107, and S109 represented in FIG. 7, and the description thereof will be omitted.

(Step S302) The DERMS 30E acquires the system information and the load power generation information of the power distribution system 5, and predicts the future of the load and the power generation amount. Thereafter, the process proceeds to the step S303. The DERMS 30E may acquire the system information of the power distribution system 5 in advance from the power distribution automation system 10.

(Step S303) The DERMS 30E calculates the power flow of the voltage and the current in the power distribution system 5 based on the system information of the power distribution system 5 and the prediction of the load and the power generation amount in the step S302. Thereafter, the process proceeds to the step S305.

The processing after the step S305 is the same as the processing represented in FIG. 7, and the DERMS 30E reduces the power distribution system 5 based on the power flow calculation result in the step S303 and the installation location of the DER (step S305), performs optimal power flow (OPF) by using the reduced power distribution system (step S307), and transmits the power control amount command to the aggregator system 20 (step S309).

As described above, in the distributed energy resource management system 1E according to the present embodiment, the DERMS 30E predicts the future of the load and the power generation amount at each point in the power distribution system 5. Then, the DERMS 30E calculates the power flow of the voltage and the current at each point in the power distribution system 5 based on the system information of the power distribution system 5 and the prediction of the load and the power generation amount at each point in the power distribution system 5.

As a result, the distributed energy resource management system 1E can optimize the power control amount of each DER connected to the power distribution system 5 based on the future prediction of the load and the power generation amount at each point in the power distribution system 5.

The distributed energy resource management system 1E represented in FIG. 14 is a configuration example in which the DERMS 30E that predicts the future of the load and the power generation amount at each point in the power distribution system 5 is provided instead of the DERMS 30 with respect to the configuration of the distributed energy resource management system 1 represented in FIG. 1, but may be configured to include the DERMS 30E instead of the DERMS 30 in the distributed energy resource management system 1A represented in FIG. 8, the distributed energy resource management system 1B represented in FIG. 9, and the distributed energy resource management system 1C represented in FIG. 10.

### Hardware Configuration

Next, hardware configurations of the power distribution automation system 10, the aggregator system 20, the DERMS 30 (30D and 30E), the transaction system 40, and the prediction system 50 according to the first to sixth embodiments will be described. The power distribution automation system 10, the aggregator system 20, the DERMS 30 (30D and 30E), the transaction system 40, and the prediction system 50 include a hardware configuration as a computer.

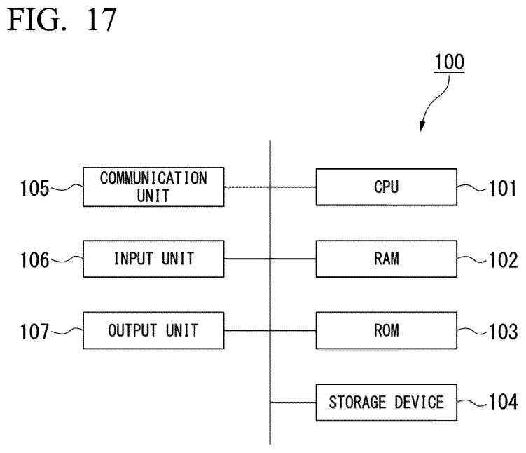

FIG. 17 is a schematic block diagram representing an example of a hardware configuration according to the present embodiment. For example, the power distribution automation system 10, the aggregator system 20, the DERMS 30 (30D and 30E), the transaction system 40, and the prediction system 50 include some or all of the configurations included in a computer 100 represented in the drawing.

The computer 100 includes, as a hardware configuration, a central processing unit (CPU) 101, a random access memory (RAM) 102, a read only memory (ROM) 103, a storage device 104, a communication unit 105, an input unit 106, and an output unit 107.

The CPU 101 is a processor that executes various types of processing by executing a program stored in the ROM 103 or the storage device 104.

The RAM 102 is used as a reading region of a program executed by the CPU 101 or as a work region in which data used for processing by the program is written.

The ROM 103 is configured of, for example, an electrically erasable programmable read only memory (EEPROM) or an electrically erasable non-volatile memory such as a flash ROM. For example, at least part of a system program, a program for executing various types processing, or the like is stored in the ROM 103.

The storage device 104 is configured to include a hard disk drive (HDD), a solid state drive (SSD), or the like. For example, at least part of a system program, a program for executing various types of processing, or the like may be stored in the storage device 104. In addition, various types of data, the electronic certificate described above, or the like is stored in the storage device 104.

The communication unit 105 is connected to the network NT by a wireless local area network (LAN) or a wired LAN, and performs data communication with another electronic apparatus. In addition, the communication unit 105 may include a short-range wireless communication such as Bluetooth (registered trademark) and an interface such as a universal serial bus (USB) and perform data communication with peripheral devices.

The input unit 106 Includes, for example, an input device sue s a keyboard, a touch pad, a touch panel, and a microphone. The output unit 107 includes a display unit such as a liquid crystal display and an organic EL display, an output device such as a speaker, or the like.

Here, the communication unit 31 represented in FIGS. 2, 12, and 15 corresponds 10, for example, the communication unit 105 represented in FIG. 17. In addition, the storage unit 32 represented in FIGS. 2, 12, and 15 corresponds to, for example, the storage device 104 represented in FIG. 17. In addition, the control unit 33 represented in FIGS. 2, 12, and 15 is a functional configuration realized when, for example, the CPU 101 represented in FIG. 17 executes a program.

Hitherto, the embodiments have bee described in detail with reference to the drawings, but specific configurations are not limited to these embodiments, and the embodiments can be appropriately modified or omitted.

In the above-described embodiment, the communication network when each of the power distribution automation system 10, the aggregator system 20, the DERMS 30 (30D and 30E), the transaction system 40, and the prediction system 50 performs communication includes the Internet, a mobile phone communication network, a local area network (LAN), or the like.

In addition, in the above-described embodiment, the example has been described in which the power distribution automation system 10, the aggregator system 20, the DERMS 30 (30D and 30E), the transaction system 40, and the prediction system 50 transmit or receive various types of information through the communication network, but various types of information may be transmitted and received using a storage medium or the like without going through the communication network.

In addition, a program for realizing the function of each of the power distribution automation system 10, the aggregator system 20, the DERMS 30 (30D and 30E), the transaction system 40, and the prediction system 50 may be recorded on a computer-readable recording medium, and the program recorded on the recording medium may be loaded into the computer system and executed to perform the processing of each function. Note that, here, the “computer system” includes an OS and hardware such as a peripheral device.

In addition, a term “computer-readable recording medium” refers to a storage device, for example, a portable medium such as a flexible disk, magneto-optic disk, a ROM, and a CD-ROM, a hard disk built in a computer system, or the like. Furthermore, the term “computer-readable recording medium” includes a medium which dynamically holds the program for a short period of time as in a communication line when the program is transmitted through a network such as the Internet or a communication line such as a telephone line, and a medium which holds the program for a certain period of time as in a volatile memory inside the computer system serving as a server or a client in that case. In addition, the program may be a program for realizing some of the above-described functions, and, further, may be a program capable of realizing the above-described functions in combination with a program already recorded in a computer system. In addition, the program may be stored in a predetermined server, and the program may be distributed (downloaded or the like) through the communication line in response to a request from another device.

In addition, some or all of the functions of each of the power distribution automation system 10, the aggregator system 20, the DERMS 30 (30D and 30E), the transaction system 40, and the prediction system 50 may be realized as an integrated circuit such as a large scale integration (LSI). Each function may be individually processed, or some or all of the functions may be integrated and processed. Also, the integrated circuit making method is not limited to the LSI, but may be realized by a dedicated circuit or a general-purpose processor. In addition, when the integrated circuit making technology that replaces the LSI appears due to advances in semiconductor technology, an integrated circuit based on the technology may be used.

### REFERENCE SIGNS LIST

1, 1A, 1B, 1C, 1D, 1E Distributed energy resource management system
5 Power distribution system
10 Power distribution automation system
20 Aggregator system
30, 30D, 30E Distributed energy resource management control device (DERMS)
31 Communication unit
32 Storage unit
33, 33A, 33B, 33C, 33D, 33E Control unit
331 Load power generation information acquisition unit
332 DER controllable amount acquisition unit
333 Power flow calculation unit
334 System reduction unit
335 Power control amount calculation unit
336 Load power generation prediction information acquisition unit
337 Load power generation amount prediction unit
40 Transaction system
50 Prediction system

1. A distributed energy resource management system comprising:
power flow calculation circuitry configured to calculate a power flow of a voltage and a current at each point in a power distribution system based on system information including information indicating an installation location and a connection form of a distributed energy resource connected to the power distribution system and load power generation information including information indicating a load and a power generation amount at each point in the power distribution system;
system reduction circuitry configured to generate a reduced power distribution system obtained by reducing the power distribution system based on a calculation result by the power flow calculation circuitry and the installation location of the distributed energy resource; and
power control amount calculation circuitry configured to calculate a power control amount controlled by the distributed energy resource by using the reduced power distribution system.

2. The distributed energy resource management system according to claim 1, further comprising:
controllable amount acquisition circuitry configured to acquire a controllable amount indicating a range of controllable power in the distributed energy resource, wherein
the power control amount calculation circuitry is configured to calculate the power control amount such that the power control amount is within a range of the controllable amount when the power control amount controlled by the distributed energy resource is calculated using the reduced power distribution system.

3. The distributed energy resource management system according to claim 1, wherein
the system reduction circuitry is configured to reduce a range in which a power flow does not change although the power control amount of the distributed energy resource is controlled in the power distribution system.

4. The distributed energy resource management system according to claim 1, wherein
the system reduction circuitry is configured to reduce a range in the power distribution system excluding a section between a voltage source and the distributed energy resource configured to control a power control amount.

5. The distributed energy resource management system according to claim 3, wherein
the system reduction circuitry is configured to handle a section of the range reduced in the power distribution system as a load according to power that flows into the section.

6. The distributed energy resource management system according to claim 3, wherein
the system reduction circuitry is configured to update a voltage upper limit value at a branch point to a section of the range reduced in the power distribution system, based on a change amount of a voltage in the section.

7. The distributed energy resource management system according to claim 1, further comprising:
communication circuitry configured to transmit the power control amount calculated by the power control amount calculation circuitry to the distributed energy resource.

8. The distributed energy resource management system according to claim 7, wherein
the communication circuitry is configured to transmit the power control amount to the distributed energy resource through a server provided in an aggregator.

9. The distributed energy resource management system according to claim 7, wherein
the communication circuitry is configured to transmit the power control amount directly to the distributed energy resource without going through a server provided in an aggregator.

10. The distributed energy resource management system according to claim 7, wherein
the communication circuitry is configured to transmit the power control amount to the distributed energy resource through a server provided by a general power transmission and distribution business operator.

11. The distributed energy resource management system according to claim 1, further comprising:
a communication circuitry configured to acquire the system information and the load power generation information from a server provided by a general power transmission and distribution business operator.

12. The distributed energy resource management system according to claim 2, wherein
the controllable amount acquisition circuitry is configured to acquire the controllable amount from a server provided in an aggregator.

13. The distributed energy resource management system according to claim 2, wherein
the controllable amount acquisition circuitry is configured to directly acquire the controllable amount from the distributed energy resource without going through a server provided in an aggregator.

14. The distributed energy resource management system according to claim 2, wherein
the controllable amount acquisition circuitry is configured to acquire the controllable amount from a server provided by a general power transmission and distribution business operator.

15. The distributed energy resource management system according to claim 1, further comprising:
prediction information acquisition circuitry configured to acquire load power generation prediction information including information indicating a future prediction of the load and the power generation amount at each point in the power distribution system, wherein
the power flow calculation circuitry is configured to calculate the power flow of the voltage and the current at each point in the power distribution system based on the system information and the load power generation prediction information.

16. The distributed energy resource management system according to claim 1, further comprising:
load power generation amount prediction circuitry configured to predict a future of the load and the power generation amount at each point in the power distribution system, wherein
the power flow calculation circuitry is configured to calculate the power flow of the voltage and the current at each point in the power distribution system based on the system information and the prediction of the load and the power generation amount by the load power generation amount prediction circuitry.

17. (canceled)

18. A control method in a distributed energy resource management system, the control method comprising:
calculating, via power flow calculation circuitry, a power flow of a voltage and a current at each point in a power distribution system based on system information including information indicating an installation location and a connection form of a distributed energy resource connected to the power distribution system and load power generation information including information indicating a load and a power generation amount at each point in the power distribution system;
generating, via system reduction circuitry, a reduced power distribution system obtained by reducing the power distribution system based on a calculation result by the power flow calculation circuitry and the installation location of the distributed energy resource; and
calculating, via power control amount calculation circuitry, a power control amount controlled by the distributed energy resource by using the reduced power distribution system.

19. A computer readable non-transitory recording medium having a program for causing a computer to execute:
calculating a power flow of a voltage and a current at each point in a power distribution system based on system information including information indicating an installation location and a connection form of a distributed energy resource connected to the power distribution system and load power generation information including information indicating a load and a power generation amount at each point in the power distribution system;
generating a reduced power distribution system obtained by reducing the power distribution system based on a calculation result of the power flow and the installation location of the distributed energy resource; and
calculating a power control amount controlled by the distributed energy resource by using the reduced power distribution system.
